(19) United States
(12) Patent Application Publication
(10) Pub. No.: US 2026/0146946 A1
(43) Pub. Date: May 28, 2026

(54) DETERMINING ROUGHNESS AND INDEX OF REFRACTION OF A MATERIAL

(71) Applicant: Adobe Inc., San Jose, CA (US)

(72) Inventors: Adrien Michel Paul Kaiser, Lyon (FR); Valentin Mathieu Deschaintre, London (GB); Jerome Eric Christophe Derel, Hauts-de-Seine (FR); Emilie Ginette Nogué, London (GB)

(73) Assignee: Adobe Inc., San Jose, CA (US)

(21) Appl. No.: 18/958,009

(22) Filed: Nov. 25, 2024

(51) Int. Cl. G01N 21/55

(52) U.S. Cl. CPC G01N 21/55; G01N 2021/556; G01N 2021/558; G01N 2201/0683

(57) ABSTRACT

In implementation of techniques for determining roughness and index of refraction of a material, a computing device implements a specular system to receive images captured of a material sample from multiple polarization angles. The specular system determines information describing light distribution and brightness of the material sample depicted in the images based on the multiple polarization angles. Based on the light distribution and the brightness of the material sample, the specular system determines a roughness property or an index of refraction property for the material sample. The specular system generates an output that visually identifies the roughness property or the index of refraction property of the material sample.

### BACKGROUND

In computer graphics, a material is described by a collection of property maps, which are two-dimensional images used to model optical parameters for virtual three-dimensional objects. For example, a material is applied to a surface of a virtual three-dimensional object to simulate an appearance of a real-life object. Different material properties are represented by different maps, including, but not limited to, normal maps, base color maps, and opacity maps. Digital material models apply the materials to virtual three-dimensional objects within a three-dimensional rendering or game engine, simulating real-life objects. However, conventional techniques used to generate materials in a virtual environment cause errors and result in visual inaccuracies and computational inefficiencies in real world scenarios.

### SUMMARY

Techniques and systems for determining roughness and index of refraction of a material are described. In an example, a specular system receives images captured of a material sample illuminated from multiple light source positions. For example, the images are captured using a camera including a rotating polarized lens and by illuminating the material sample from different angles with multiple linearly-polarized light sources.

The specular system determines information describing light distribution and brightness of the material sample depicted in the images based on the multiple polarization angles. For instance, the information describing the light distribution and the brightness of the material sample is based on light measurements that include diffuse reflectance values.

Based on the light distribution and the brightness of the material sample, the specular system determines a roughness property and/or an index of refraction property for the material sample. In some examples, the specular system compares the light distribution and the brightness of the material sample to determine the roughness property and/or the index or refraction property. For example, the roughness property predicts how a surface of the material sample distributes light based on its roughness and the index of refraction property predicts brightness of a surface of the material sample.

The specular system generates an output that visually identifies the roughness property and/or the index or refraction property of the material sample. Some examples further comprise generating a roughness map based on the roughness property or an index of refraction map based on the index of refraction property and applying a virtual material based on the material sample to a virtual three-dimensional object using the roughness map or the index of refraction map.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ techniques and systems for determining roughness and index of refraction of a material as described herein.

FIG. 2 depicts a system in an example implementation showing operation of a mesh progression module for determining roughness and index of refraction of a material.

FIG. 3 depicts an example of receiving an input including images.

FIG. 4 depicts an example of separating a specular signal from a diffuse signal.

FIG. 5 depicts an example of isolating a roughness value and an index of refraction value from an amplitude of the specular signal.

FIG. 6 depicts an example of a lookup table.

FIG. 7 depicts a procedure in an example implementation of determining roughness and index of refraction of a material.

FIG. 8 depicts a procedure in an additional example implementation of determining roughness and index of refraction of a material.

FIG. 9 depicts a procedure in an additional example implementation of determining roughness and index of refraction of a material.

FIG. 10 illustrates an example system including various components of an example device that can be implemented as any type of computing device as described and/or utilized with reference to FIGS. 1-9 to implement embodiments of the techniques described herein.

### DETAILED DESCRIPTION

### Overview

Virtual reproductions of real-life materials are generated for application to surfaces of virtual three-dimensional objects to create realistic virtual environments for gaming, advertising, entertainment, and other applications. To generate a virtual version of a material sample, a variety of property maps are generated that illustrate various physical properties of the material sample, including normal maps, base color maps, and opacity maps. In addition to the property maps, roughness values and index of refraction values are useful to re-create texture of the material sample in the virtual environment. Roughness affects the way light scatters when it hits the surface. Surfaces with high roughness values, for instance, appear matte, while surfaces with low roughness values appear glossy. Index of refraction measures how much light bends or refracts when it passes from one medium into another. Surfaces with a higher index of refraction value, for example, are more reflective. Although realistic virtual materials are generated using roughness values and index of refraction values, these values are difficult to determine from real-life material samples.

Conventional roughness and index of refraction determination techniques attempt to use a neural network to predict roughness and index of refraction for a material sample. However, these applications do not produce accurate predictions because the neural network receives as input a single image of the material sample illuminated from a single direction. Therefore, the neural network estimates the roughness and the index of refraction with limited knowledge on how light interacts with the material from other angles. Additionally, the neural network for conventional roughness and index of refraction determination techniques relies on large training datasets including examples of lighting on material surfaces and is slow to generate estimations.

Techniques and systems are described for determining roughness and index of refraction of a material that overcome these limitations. For example, an amplitude of a specular signal is determined that corresponds to light purely reflected on the material sample, which is illuminated from multiple known light source positions and captured by a polarized camera. The amplitude of the specular signal is used in determining actual roughness and index of refraction values for the material sample instead of generating predictions based on limited data, as performed by conventional roughness and index of refraction determination techniques.

In an example, a specular system begins by receiving an input including images depicting a material sample, captured from multiple light positions and polarization angles. The images, for instance, are captured by a material imaging device using a polarized camera mounted above the material sample. In this example, eight angled light panels take turns illuminating the material sample from different known angles while the overhead polarized camera captures the images of the material sample from different polarization angles. The images, for instance, include a set of sixty-four images, captured from eight different polarization angles and depicting the material sample illuminated from eight different directions.

The specular system then determines an amplitude of a specular signal for the material sample based on the images by separating the specular signal from the diffuse signal measured from the images. For instance, the specular signal measures an intensity of light across different wavelengths under controlled lighting conditions. The amplitude of the specular signal indicates light distribution information and brightness information for the material sample. The light distribution information is dependent on the roughness value, and the brightness information is dependent on the index of refraction value.

The specular system then isolates the roughness value and the index of refraction value from the amplitude of the specular signal. For example, the amplitude of the specular signal correlates to a Fresnel coefficient of parallel reflectance multiplied by a light distribution value. The Fresnel coefficient of parallel reflectance is a function of the index of refraction value, and the light distribution value is a function of the roughness value. Therefore, to obtain the roughness value, the specular system divides the amplitude of the specular signal by the Fresnel coefficient related to a given index of refraction value to obtain a light distribution value, which depends on roughness. A lookup table is then used to determine the roughness value based on the light distribution value. In contrast, to obtain the index of refraction value, the specular system divides the amplitude of the specular signal by a light distribution value related to a given roughness value to obtain a Fresnel coefficient, which depends on index of refraction. A lookup table is then used to determine the index of refraction value based on the Fresnel coefficient.

The specular system then generates an output indicating the roughness value and the index of refraction value. In some examples, the output includes a roughness map or an index of refraction map. The roughness map, for instance, visually illustrates differences in roughness on the material sample, and the index of refraction map visually illustrates differences in index of refraction on the material sample. For example, the roughness map or the index of refraction map is used to accurately apply texture from a material sample to a virtual object.

Determining roughness and index of refraction of a material in this manner overcomes the limitations of conventional roughness and index of refraction determination techniques that are limited to using a neural network to predict roughness and index of refraction based on a single image of the material sample illuminated from a single direction. In contrast, determining an amplitude of a specular signal corresponding to light reflected on the material sample illuminated from multiple known polarization angles results in determining actual roughness and index of refraction values for the material sample instead of generating predictions based on limited data. Additionally, determining roughness and index of refraction of a material in this manner is faster and does not involve the large training datasets relied on by the conventional roughness and index of refraction determination techniques.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

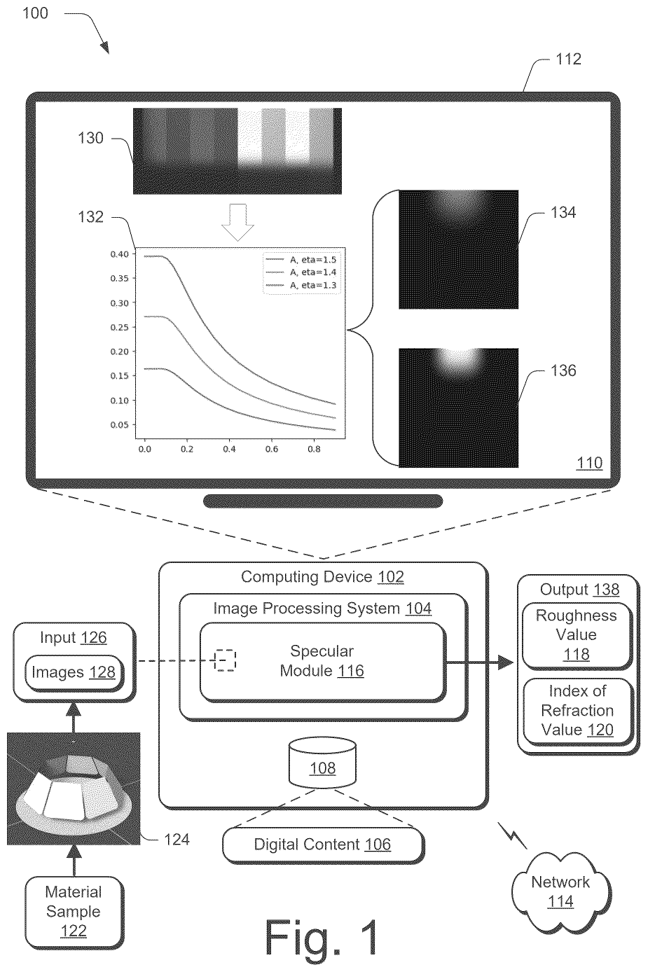

FIG. 1 is an illustration of a digital medium environment 100 in an example implementation that is operable to employ techniques and systems for determining roughness and index of refraction of a material described herein. The illustrated digital medium environment 100 includes a computing device 102, which is configurable in a variety of ways.

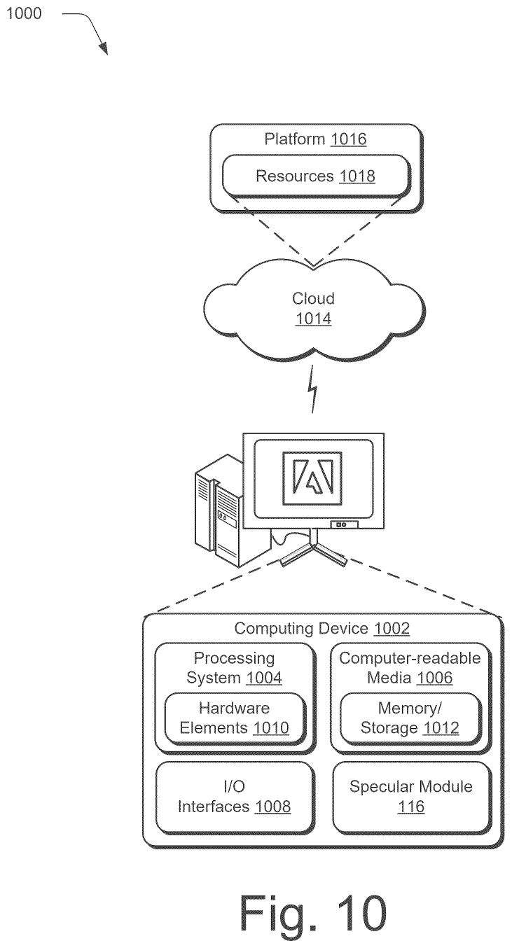

The computing device 102, for instance, is configurable as a desktop computer, a laptop computer, a mobile device (e.g., assuming a handheld configuration such as a tablet or mobile phone), an augmented reality device, and so forth. Thus, the computing device 102 ranges from full resource devices with substantial memory and processor resources (e.g., personal computers, game consoles) to a low-resource device with limited memory and/or processing resources, e.g., mobile devices. Additionally, although a single computing device 102 is shown, the computing device 102 is also representative of a plurality of different devices, such as multiple servers utilized by a business to perform operations “over the cloud” as described in FIG. 10.

The computing device 102 also includes an image processing system 104. The image processing system 104 is implemented at least partially in hardware of the computing device 102 to process and represent digital content 106, which is illustrated as maintained in storage 108 of the computing device 102. Such processing includes creation of the digital content 106, representation of the digital content 106, modification of the digital content 106, and rendering of the digital content 106 for display in a user interface 110 for output, e.g., by a display device 112. Although illustrated as implemented locally at the computing device 102, functionality of the image processing system 104 is also configurable entirely or partially via functionality available via the network 114, such as part of a web service or “in the cloud.”

The computing device 102 also includes a specular module 116 which is illustrated as incorporated by the image processing system 104 to process the digital content 106. In some examples, the specular module 116 is separate from the image processing system 104 such as in an example in which the specular module 116 is available via the network 114.

The specular module 116 is configured to determine a roughness value 118 and an index of refraction value 120 for a material sample 122. The roughness value 118 indicates hardness or softness of a reflection on a surface, while the index of refraction value 120 indicates brightness or dimness of the reflection, which influences canniness of a material. The material sample 122, for instance is input to a material imaging device 124 that generates an input 126 including images 128 of the material sample 122. The images 128 are captured by rotating a light source around the material sample 122. The material imaging device 124 includes an overhead polarized camera that captures the images 128 and one or more light sources that rotate around a perimeter of the material sample 122, illuminating the material sample 122 from different angles. In this example, the material imaging device 124 includes a flat surface for placement of the material sample 122 and eight angled light panels. The eight angled light panels take turns illuminating the material sample 122 while the overhead polarized camera captures the images 128 of the material sample 122. The images 128, for instance, include a set of sixty-four images capturing views of the material sample 122 from eight different polarization angles and illuminated from eight different lighting directions.

The specular module 116 receives the input 126 including the images 128 and isolates a specular signal 130 from a diffuse signal based on the images 128 by neglecting polarized non-specular signals. The specular signal 130 is characterized by reflection in a specific, predictable direction, maintaining an angle of incidence equivalent to the angle of reflection. The specular signal 130 occurs when a signal encounters a smooth surface, causing a reflection in a single direction. In contrast, a diffuse signal occurs when a signal reflects off a rough or irregular surface, scattering in multiple directions.

The specular module 116 measures an amplitude 132 of the specular signal 130, which is used to calculate the roughness value 118 and the index of refraction value 120. Both the roughness value 118 and the index of refraction value 120 contribute to the amplitude 132 of the specular signal 130. For instance, the amplitude 132 of the specular signal 130 correlates to a Fresnel coefficient of parallel reflectance multiplied by a light distribution value. The Fresnel coefficient of parallel reflectance is a function of the index of refraction value 120, and the light distribution value is a function of the roughness value 118. Therefore, to obtain the roughness value 118, the specular module 116 divides the amplitude 132 of the specular signal 130 by the Fresnel coefficient related to an index of refraction value 120 to obtain a light distribution value, which depends on roughness. The specular module 116 then uses a lookup table to determine the roughness value 118 based on the light distribution value. In contrast, to obtain the index of refraction value 120, the specular module 116 divides the amplitude 132 of the specular signal 130 by a light distribution value related to a roughness value 118 to obtain a Fresnel coefficient, which depends on index of refraction. The specular module 116 then uses a lookup table to determine the index of refraction value 120 based on the Fresnel coefficient. The roughness value 118 and the index of refraction value 120 are determined on a per-pixel basis.

In some examples, the specular module 116 also generates a specular rendering for a given roughness and index of refraction. The specular module 116 also generates a roughness map that simulates how light interacts with the surface of the material sample 122, determining its level of roughness at different points. For instance, the roughness map indicates the appearance of specular reflections by defining whether a surface is smooth (low roughness) or rough (high roughness). A smoother surface results in sharp, well-defined reflections, while a rougher surface produces more diffuse, blurred reflections. The specular module 116 also generates an index of refraction map that illustrates how much light slows down and changes direction when entering the material sample 122, influencing the appearance of effects like distortion, magnification, and internal reflections. The index of refraction map assigns varying index of refraction values to different regions of the index of refraction map, resulting in realistic simulations of how light interacts with non-uniform surfaces of the material sample 122.

The specular module 116 then generates an output 138 indicating the roughness value 118 and/or the index of refraction value 120, further examples of which are described in the following sections and shown in corresponding figures. For instance, the roughness value 118 and/or the index of refraction value 120, as well as the corresponding roughness map and the index of refraction map are available to apply the material sample 122 to a realistic object in a virtual three-dimensional environment.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Determining Roughness and Index of Refraction of a Material

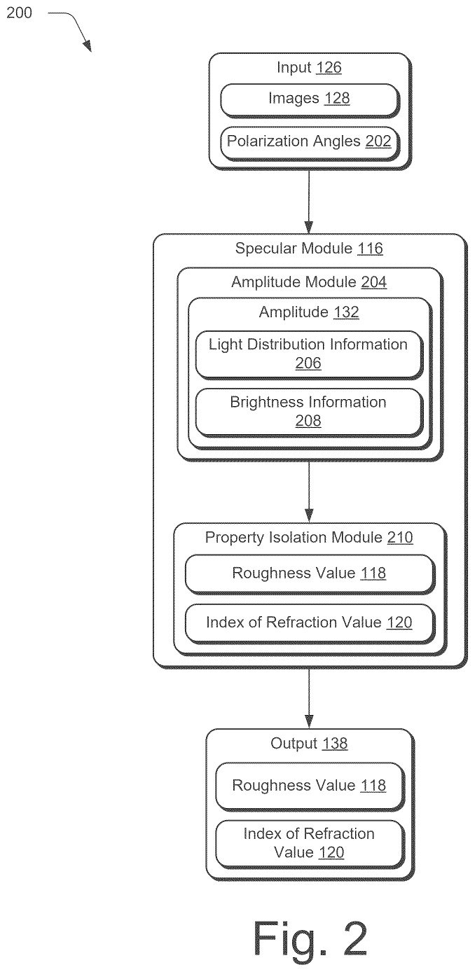

FIG. 2 depicts a system 200 in an example implementation showing operation of the specular module 116 of FIG. 1 in greater detail. The following discussion describes techniques that are implementable utilizing the previously described systems and devices. Aspects of each of the procedures are implemented in hardware, firmware, software, or a combination thereof. The procedures are shown as a set of blocks that specify operations performed and/or caused by one or more devices and are not necessarily limited to the orders shown for performing the operations by the respective blocks. In portions of the following discussion, reference is made to FIGS. 1-10.

To begin in this example, a specular module 116 receives an input 126 including images 128 depicting a material sample 122, captured using multiple polarization angles 202 and illuminated from multiple light positions. The images 128, for instance, are captured by a material imaging device 124 using a polarized camera mounted above the material sample 122 and configured to capture the images 128 from different polarization angles while the light direction changes between capture of the images 128. In this example, eight angled light panels take turns illuminating the material sample 122 while the overhead polarized camera captures the images 128 of the material sample 122. The images 128, for instance, include a set of sixty-four images depicting the material sample 122 captured from eight different polarization angles.

The specular module 116 includes an amplitude module 204. The amplitude measures an amplitude 132 of a specular signal 130 for the material sample 122 based on the images 128. To obtain the amplitude 132 of the specular signal 130, the specular module 116 separates the specular signal 130 from the diffuse signal measured from the images 128. For instance, the specular signal 130 measures an intensity of light across different wavelengths under controlled lighting conditions where pixels in the images 128 represent the intensity of light reflected or emitted by the scene at specific wavelengths. The amplitude 132 of the specular signal 130 indicates light distribution information 206 and brightness information 208 for the material sample 122. The light distribution information 206 corresponds to the roughness value 118, and the brightness information 208 corresponds to the index of refraction value 120.

The specular module 116 also includes a property isolation module 210, which isolates a roughness value 118 and an index of refraction value 120 from the amplitude 132 of the specular signal 130. The amplitude 132 of the specular signal 130 correlates to a Fresnel coefficient of parallel reflectance multiplied by a light distribution value. The Fresnel coefficient of parallel reflectance is a function of the index of refraction value 120, and the light distribution value is a function of the roughness value 118. Therefore, to obtain the roughness value 118, the specular module 116 divides the amplitude 132 of the specular signal 130 by the Fresnel coefficient related to an index of refraction value 120 to obtain a light distribution value, which depends on roughness. The specular module 116 then uses a lookup table to determine the roughness value 118 based on the light distribution value. In contrast, to obtain the index of refraction value 120, the specular module 116 divides the amplitude 132 of the specular signal 130 by a light distribution value related to a roughness value 118 to obtain a Fresnel coefficient, which depends on index of refraction. The specular module 116 then uses a lookup table to determine the index of refraction value 120 based on the Fresnel coefficient. In this example, the specular module 116 determines the roughness value 118 and the index of refraction value 120 on a per-pixel basis.

The specular module 116 then generates an output 138 indicating the roughness value 118 and the index of refraction value 120. In some examples, the output 138 includes a roughness map and/or an index of refraction map. The roughness map, for instance, visually illustrates differences in roughness on the material sample 122, while the index of refraction map visually illustrates differences in index of refraction on the material sample 122. The roughness map and the index of refraction map are used in some examples to accurately apply texture from a material sample 122 to a virtual object.

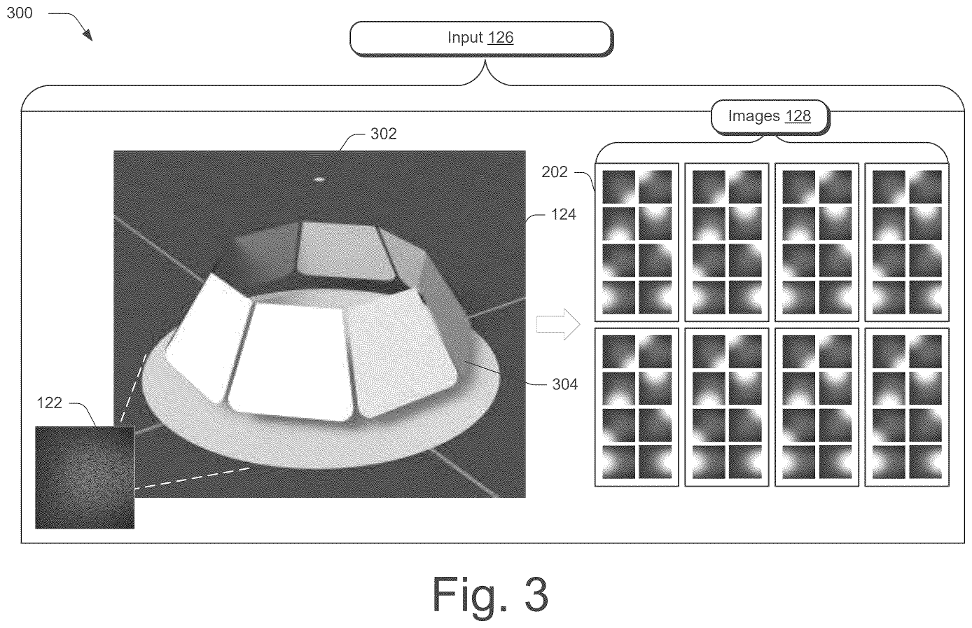

FIGS. 3-6 depict stages of determining roughness and index of refraction of a material. In some examples, the stages depicted in these figures are performed in a different order than described below.

FIG. 3 depicts an example 300 of receiving an input including images. As illustrated, the specular module 116 receives images 128 of a material sample 122 captured from multiple polarization angles 202.

The images 128 are captured, for instance, by a material imaging device 124. The material imaging device 124 includes a camera 302, light panels 304, and a sample holder for positioning the material sample 122. The camera 302 in this example is a polarized camera. The polarized camera is a type of imaging device equipped with polarizing filters that capture light waves based on their polarization state, which refers to the orientation of the light's electric field.

Unlike standard cameras, which measure the intensity and color of light, polarized cameras detect the direction of light wave oscillations, providing additional information about the surface properties and material composition of objects. The polarized camera has a lens that filters light wavelengths by selectively blocking waves based on their polarization orientation. Light waves vibrate in different directions, and a polarizing filter on the lens allows the light waves oscillating in a specific direction (e.g., horizontal or vertical) to pass through while absorbing or reflecting waves oriented differently. When these filters are placed in front of the camera sensor or incorporated into individual pixels, the camera captures images that highlight differences in polarization, rather than mere intensity or color. Some polarized cameras use multiple polarization filters oriented at different angles (e.g., 0°, 45°, 90°, and 135°) to measure various polarization states simultaneously to capture polarization information across different wavelengths.

As illustrated in this example, the material imaging device 124 includes eight light panels arranged in an octagon arrangement around the material sample 122. The eight light panels take turns illuminating the material sample 122 while the camera 302 captures the images 128 of the material sample 122. The images 128, for instance, include a set of sixty-four images that depict the material sample 122 from eight different polarization angles and illuminated from eight different directions.

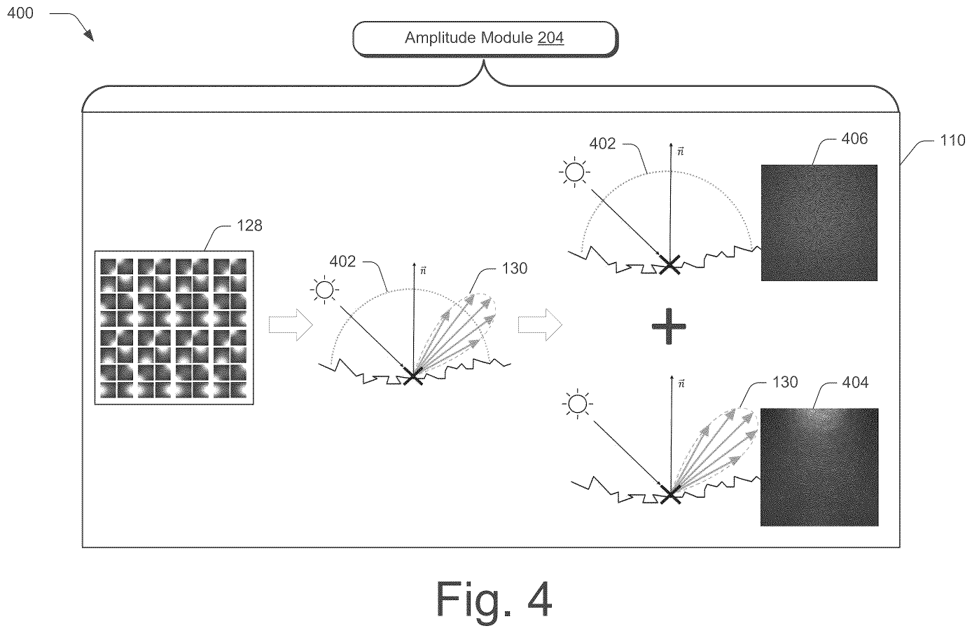

FIG. 4 depicts an example 400 of separating a specular signal from a diffuse signal. FIG. 4 is a continuation of the example described in FIG. 3. After receiving the input 126 including the images 128 capturing the material sample 122, the amplitude module 204 of the specular module 116 separates a specular signal 130 from a diffuse signal 402.

The images 128 captured by the material imaging device 124 include data related to both a specular signal 130 and a diffuse signal 402. The specular signal 130 is characterized by reflection in a specific, predictable direction, maintaining an angle of incidence equivalent to the angle of reflection. The specular signal 130 occurs when a signal encounters a smooth surface, causing a reflection in a single direction. In contrast, a diffuse signal 402 occurs when a signal reflects off a rough or irregular surface, scattering in multiple directions.

To separate the specular signal 130 from the diffuse signal 402, the amplitude module 204 neglects polarized non-specular signals measured from the images 128. In some examples, the separation of the specular signal 130 from the diffuse signal 402 involves image decomposition of the images 128. Because the images 128 are captured under different polarization states, the specular component exhibits greater intensity variation, while the diffuse component remains relatively constant. In an example, the light distribution information 206 performs color-space separation by examining the chromaticity of the reflected light of the material sample 122, as specular reflections tend to retain the color of the light source, while diffuse reflections take on the color of the material sample 122. This isolates the specular highlights for separation of the specular signal 130 from the diffuse signal 402. The specular signal 130 is illustrated on a specular image 404 for each light panel, while the diffuse signal 402 is illustrated on a diffuse image 406 for each light panel. For instance, for eight light panels, there are eight specular images and eight diffuse images.

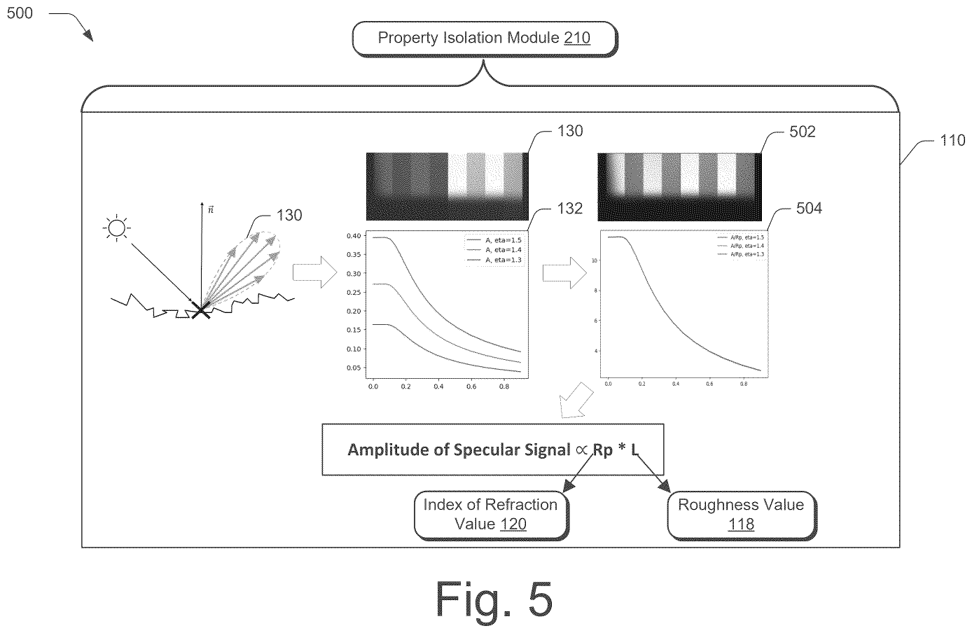

FIG. 5 depicts an example 500 of isolating a roughness value and an index of refraction value from an amplitude of the specular signal. FIG. 5 is a continuation of the example described in FIG. 4. After the amplitude module 204 of the specular module 116 separates a specular signal 130 from a diffuse signal 402, the property isolation module 210 isolates a roughness value 118 from an index of refraction value 120.

The specular module 116 measures an amplitude 132 of the specular signal 130, which is used to calculate the roughness value 118 and the index of refraction value 120. Both the roughness value 118 and the index of refraction value 120 contribute to the amplitude 132 of the specular signal 130. The amplitude 132 of the specular signal 130 correlates to a Fresnel coefficient of parallel reflectance multiplied by a light distribution value. The Fresnel coefficient of parallel reflectance is a function of the index of refraction value 120, and the light distribution value is a function of the roughness value 118. The amplitude 132 of the specular signal 130 is calculated for the individual pixels of the images 128 by averaging a cosine. An equation representing the specular signal 130 is:

Amplitude of Specular Signal∝Rp*L

where Rp is the Fresnel coefficient of parallel reflectance, and L is the redistribution of light by the material sample 122. The Fresnel coefficient of parallel reflectance, for instance, quantifies the amount of light that is reflected from a surface when the incident light is polarized parallel to the plane of incidence. The redistribution of light by the material sample 122 refers to how incident light is scattered, absorbed, transmitted, or reflected by the surface of the material sample 122 and internal structure of the material sample 122. The way light is redistributed depends on the material sample 122 optical properties, such as surface roughness, refractive index, absorption coefficient, and internal microstructure. Materials with smooth, shiny surfaces reflect light in a more specular manner, while rough or matte materials scatter light more diffusely. Transparent or translucent materials further transmit light, potentially bending and scattering it within due to internal inhomogeneities.

Therefore, to obtain the roughness value 118, the specular module 116 divides the amplitude 132 of the specular signal 130 by the Fresnel coefficient related to an index of refraction value 120 to obtain a light distribution value, which depends on roughness. The specular module 116 then uses a lookup table to determine the roughness value 118 based on the light distribution value. In contrast, to obtain the index of refraction value 120, the specular module 116 divides the amplitude 132 of the specular signal 130 by a light distribution value related to a roughness value 118 to obtain a Fresnel coefficient, which depends on index of refraction. The specular module 116 then uses a lookup table to determine the index of refraction value 120 based on the Fresnel coefficient. As illustrated, the amplitude divided by the Fresnel coefficient Rp 502 indicates a proportional amplitude 504 of the specular signal 130 to the Fresnel coefficient Rp, and the proportion is defined by the light distribution.

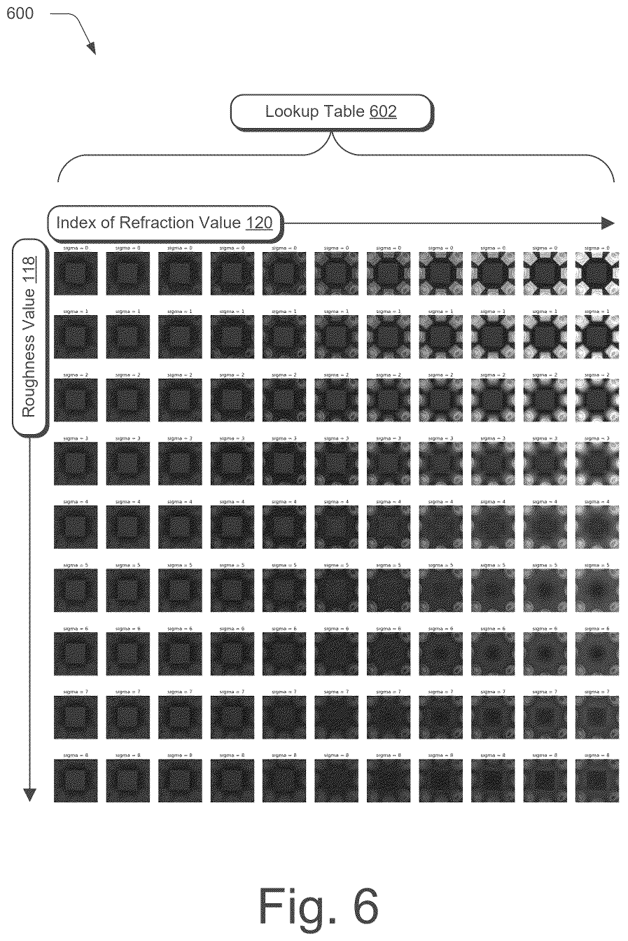

FIG. 6 depicts an example 600 of a lookup table. FIG. 6 is a continuation of the example described in FIG. 5. The lookup table 602 illustrates correlations between the roughness value 118 and the index of refraction value 120. For example, the lookup table 602 is precomputed in some examples using a range of possible roughness and possible index of refraction values. The lookup table 602 allows a roughness value 118 or an index of refraction value 120 to be recovered for an amplitude 132 for each pixel. Additionally, the lookup table 602 allows a roughness value and an index of refraction value to be predicted for a new amplitude value measured from a given material sample.

In some examples, the specular module 116 also generates a roughness map based on the roughness value 118 and/or an index of refraction map based on the index of refraction value 120. The roughness map simulates how light interacts with the surface of the material sample 122, determining its level of roughness at different points. The roughness map indicates the appearance of specular reflections by defining whether a surface is smooth (low roughness) or rough (high roughness). A smoother surface results in sharp, well-defined reflections, while a rougher surface produces more diffuse, blurred reflections. The index of refraction map illustrates how much light slows down and changes direction when entering the material sample 122, influencing the appearance of effects like distortion, magnification, and internal reflections. The index of refraction map assigns varying index of refraction values to different regions of the index of refraction map, resulting in realistic simulations of how light interacts with non-uniform surfaces of the material sample 122.

The specular module 116 then generates an output 138 indicating the roughness value 118 and/or the index of refraction value 120. For instance, the roughness value 118 and/or the index of refraction value 120, as well as the corresponding roughness map and the index of refraction map are available to apply the material sample 122 to a realistic object in a virtual three-dimensional environment.

### Example Procedures

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-10.

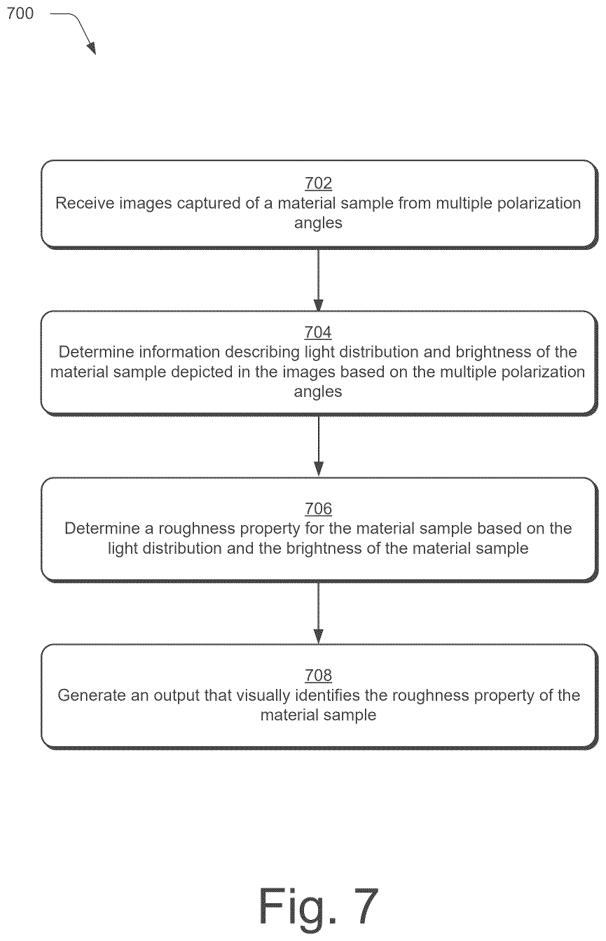

FIG. 7 depicts a procedure 700 in an example implementation of determining roughness and index of refraction of a material. At block 702 images 128 captured of a material sample 122 from multiple polarization angles are received. For example, the images 128 are captured using a camera 302 including a polarized lens and by illuminating the material sample 122 from different angles with a rotating light source.

At block 704, information describing light distribution and brightness of the material sample 122 depicted in the images 128 is determined based on the multiple polarization angles. In some examples, the information describing the light distribution and the brightness of the material sample 122 is based on light measurements that include diffuse reflectance values. Some examples further comprise separating diffuse properties from the light measurements to obtain specular properties. In some examples, the information describing the light distribution and the brightness of the material sample 122 is a polarized specular signal amplitude and is a product of a Fresnel coefficient of parallel reflectance and a redistribution of light by the material sample 122.

At block 706, a roughness property for the material sample 122 is determined based on the light distribution and the brightness of the material sample 122. Some examples include comparing the light distribution and the brightness of the material sample 122. For example, the roughness property predicts how a surface of the material sample 122 distributes light based on its roughness.

At block 708, an output that visually identifies the roughness property of the material sample 122 is generated. Some examples further comprise generating a roughness map based on the roughness property and applying a virtual material based on the material sample 122 to a virtual three-dimensional object using the roughness map.

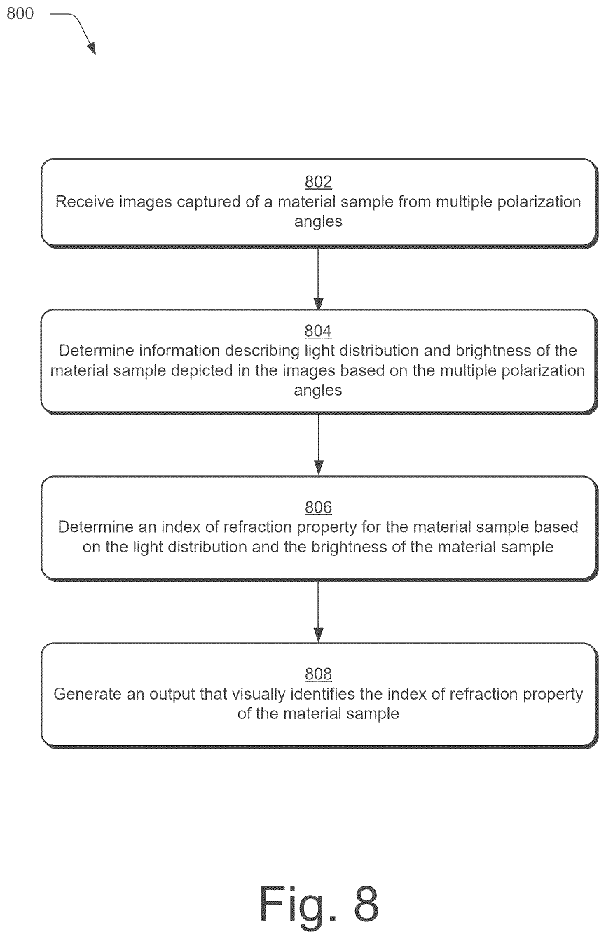

FIG. 8 depicts a procedure 800 in an additional example implementation of determining roughness and index of refraction of a material. At block 802, images 128 captured of a material sample 122 from multiple polarization angles are received. For example, the images 128 are captured by illuminating the material sample 122 from different angles with a rotating light source.

At block 804, information describing light distribution and brightness of the material sample 122 depicted in the images 128 is determined based on the multiple polarization angles. In some examples, the information describing the light distribution and the brightness of the material sample 122 is based on light measurements that include diffuse reflectance values. For example, the information describing the light distribution and the brightness of the material sample 122 is a polarized specular signal amplitude and is a product of a Fresnel coefficient of parallel reflectance and a redistribution of light by the material sample 122.

At block 806, an index of refraction property for the material sample 122 is determined based on the light distribution and the brightness of the material sample 122. In some examples, the index of refraction property predicts brightness of a surface of the material sample 122.

At block 808, an output that visually identifies the index of refraction property of the material sample 122 is generated. Some examples further comprise generating an index of refraction map based on the index of refraction property and applying a virtual material based on the material sample 122 to a virtual three-dimensional object using the index of refraction map.

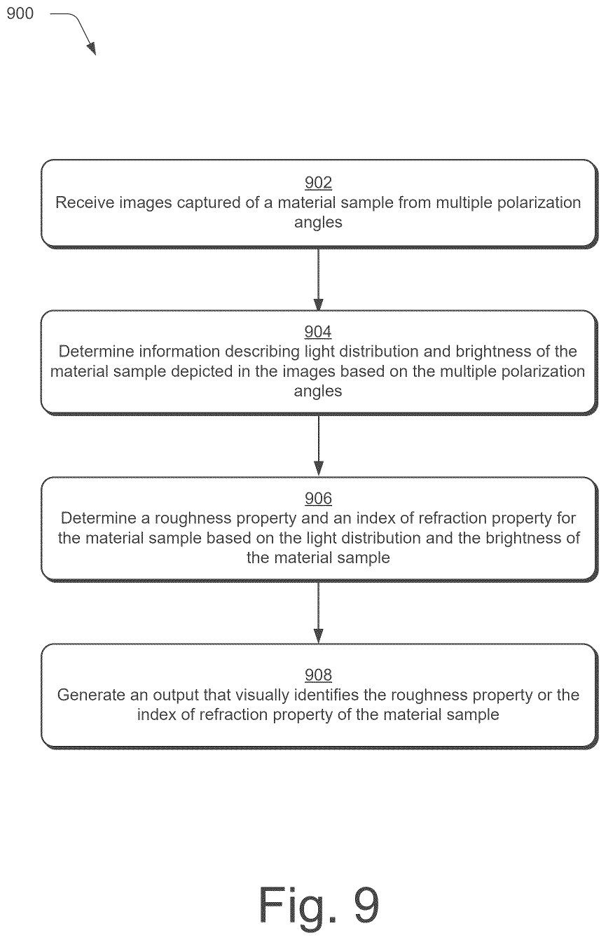

FIG. 9 depicts a procedure 900 in an additional example implementation of determining roughness and index of refraction of a material. At block 902, images 128 captured of a material sample 122 captured from multiple polarization angles are received. In some examples, the images 128 are captured by illuminating the material sample 122 from different angles with a rotating light source.

At block 904, information describing light distribution and brightness of the material sample 122 depicted in the images 128 is determined based on the multiple polarization angles. For example, the information describing the light distribution and the brightness of the material sample 122 is based on light measurements that include diffuse reflectance values. Some examples further comprise separating diffuse properties from the light measurements to obtain specular properties.

At block 906, a roughness property and an index of refraction property for the material sample 122 are determined based on the light distribution and the brightness of the material sample 122. For example, to obtain the roughness property, the information describing the light distribution and the brightness of the material sample is divided by a Fresnel coefficient related to an index of refraction property to obtain a light distribution that depends on roughness and used to determine the roughness property using a lookup table. In contrast, to obtain the index of refraction property, the information describing the light distribution and the brightness of the material sample is divided by a light distribution related to a roughness property to obtain a Fresnel coefficient that depends on index of refraction and used to determine the index of refraction property using a lookup table.

At block 908, an output that visually identifies the roughness property or the index of refraction property of the material sample 122 is generated. Some examples further comprise generating a roughness map based on the roughness property or an index of refraction map based on the index of refraction property and applying a virtual material based on the material sample 122 to a virtual three-dimensional object using the roughness map or the index of refraction map.

### Example System and Device

FIG. 10 illustrates an example system generally at 1000 that includes an example computing device 1002 that is representative of one or more computing systems and/or devices that implement the various techniques described herein. This is illustrated through inclusion of the specular module 116. The computing device 1002 is configurable, for example, as a server of a service provider, a device associated with a client (e.g., a client device), an on-chip system, and/or any other suitable computing device or computing system.

The example computing device 1002 as illustrated includes a processing system 1004, one or more computer-readable media 1006, and one or more I/O interface 1008 that are communicatively coupled, one to another. Although not shown, the computing device 1002 further includes a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware element 1010 that is configurable as processors, functional blocks, and so forth. This includes implementation in hardware as an application specific integrated circuit or other logic device formed using one or more semiconductors. The hardware elements 1010 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1006 is illustrated as including memory/storage 1012. The memory/storage 1012 represents memory/storage capacity associated with one or more computer-readable media. The memory/storage 1012 includes volatile media (such as random access memory (RAM)) and/or nonvolatile media (such as read only memory (ROM), Flash memory, optical disks, magnetic disks, and so forth). The memory/storage 1012 includes fixed media (e.g., RAM, ROM, a fixed hard drive, and so on) as well as removable media (e.g., Flash memory, a removable hard drive, an optical disc, and so forth). The computer-readable media 1006 is configurable in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1002. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1002, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1010. The computing device 1002 is configured to implement particular instructions and/or functions corresponding to the software and/or hardware modules. Accordingly, implementation of a module that is executable by the computing device 1002 as software is achieved at least partially in hardware, e.g., through use of computer-readable storage media and/or hardware elements 1010 of the processing system 1004. The instructions and/or functions are executable/operable by one or more articles of manufacture (for example, one or more computing devices and/or processing systems 1004) to implement techniques, modules, and examples described herein.

The techniques described herein are supported by various configurations of the computing device 1002 and are not limited to the specific examples of the techniques described herein. This functionality is also implementable through use of a distributed system, such as over a “cloud” 1114 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 include applications and/or data that can be utilized when computer processing is executed on servers that are remote from the computing device 1002. Resources 1018 can also include services provided over the Internet and/or through a subscriber network, such as a cellular or Wi-Fi network.

The platform 1016 abstracts resources and functions to connect the computing device 1002 with other computing devices. The platform 1016 also serves to abstract scaling of resources to provide a corresponding level of scale to encountered demand for the resources 1018 that are implemented via the platform 1016. Accordingly, in an interconnected device embodiment, implementation of functionality described herein is distributable throughout the system 1000. For example, the functionality is implementable in part on the computing device 1002 as well as via the platform 1016 that abstracts the functionality of the cloud 1014.

What is claimed is:

1. A method comprising:
receiving, by a processing device, images captured of a material sample from multiple polarization angles;
determining, by the processing device, information describing light distribution and brightness of the material sample depicted in the images based on the multiple polarization angles;
determining, by the processing device, a roughness property for the material sample based on the light distribution and the brightness of the material sample; and
generating, by the processing device, an output that visually identifies the roughness property of the material sample.

2. The method of claim 1, further comprising generating a roughness map of the material sample based on the roughness property.

3. The method of claim 2, further comprising applying a virtual material based on the material sample to a virtual three-dimensional object using the roughness map.

4. The method of claim 1, wherein the determining includes comparing the light distribution and the brightness of the material sample.

5. The method of claim 1, wherein the images are captured using a camera including a polarized lens and by illuminating the material sample from different angles with a rotating light source.

6. The method of claim 1, wherein the information describing the light distribution and the brightness of the material sample is based on light measurements that include diffuse reflectance values.

7. The method of claim 6, further comprising separating diffuse properties from the light measurements to obtain specular properties.

8. The method of claim 1, wherein the roughness property predicts how a surface of the material sample distributes light based on its roughness.

9. The method of claim 1, wherein the information describing the light distribution and the brightness of the material sample is a polarized specular signal amplitude and is a product of a Fresnel coefficient of parallel reflectance and a redistribution of light by the material sample.

10. A non-transitory computer-readable storage medium storing executable instructions, which when executed by a processing device, cause the processing device to perform operations comprising:
receiving images captured of a material sample from multiple polarization angles;
determining information describing light distribution and brightness of the material sample depicted in the images based on the multiple polarization angles;
determining an index of refraction property for the material sample based on the light distribution and the brightness of the material sample; and
generating an output that visually identifies the index of refraction property of the material sample.

11. The non-transitory computer-readable storage medium of claim 10, further configured to generate an index of refraction map of the material sample based on the index of refraction property.

12. The non-transitory computer-readable storage medium of claim 11, further configured to apply a virtual material based on the material sample to a virtual three-dimensional object using the index of refraction map.

13. The non-transitory computer-readable storage medium of claim 10, wherein the images are captured by illuminating the material sample from different angles with a rotating light source.

14. The non-transitory computer-readable storage medium of claim 10, wherein the information describing the light distribution and the brightness of the material sample is based on light measurements that include diffuse reflectance values.

15. The non-transitory computer-readable storage medium of claim 10, wherein the index of refraction property predicts brightness of a surface of the material sample.

16. The non-transitory computer-readable storage medium of claim 10, wherein the information describing the light distribution and the brightness of the material sample is a polarized specular signal amplitude and is a product of a Fresnel coefficient of parallel reflectance and a redistribution of light by the material sample.

17. A system comprising:
means for receiving images captured of a material sample from multiple polarization angles;
means for determining information describing light distribution and brightness of the material sample depicted in the images based on the multiple polarization angles;
means for determining a roughness property and an index of refraction property for the material sample based on the light distribution and the brightness of the material sample; and
means for generating an output that visually identifies the roughness property or the index of refraction property of the material sample.

18. The system of claim 17, wherein the images are captured by illuminating the material sample from different angles with a rotating light source.

19. The system of claim 17, wherein the information describing the light distribution and the brightness of the material sample is based on light measurements that include diffuse reflectance values.

20. The system of claim 19, further comprising separating diffuse properties from the light measurements to obtain specular properties.
